(19) United States
(12) Patent Application Publication
(10) Pub. No.: US 2026/0138240 A1
(43) Pub. Date: May 21, 2026

(54) TOOL, METHOD, AND SYSTEM FOR REMOVING A TAPE CARTRIDGE FROM A TAPE CARTRIDGE STORAGE DEVICE

(71) Applicant: International Business Machines Corporation, Armonk, NY (US)

(72) Inventors: Phillip Marvin Hauffe, Sehnde (DE); Thomas Peter, Ellerstadt (DE); Erik Rueger, Ockenheim (DE); Marcus Haupt, Bonn (DE)

(21) Appl. No.: 19/027,487

(22) Filed: Jan. 17, 2025

(30) Foreign Application Priority Data
Nov. 20, 2024 (GB) 2417037.5

(51) Int. Cl. B25B 9/02

(52) U.S. Cl. CPC B25B 9/02

(57) ABSTRACT

A tape cartridge removal tool for removing a tape cartridge from a tape cartridge storage device, the tape cartridge removal tool comprising: a handle to carry the removed tape cartridge, a support structure to which the handle is attached, having a first side facing the handle and a second side, opposite the first side, and two latching hooks, the latching hooks extending from the second side of the support structure away from the handle. The latching hooks are designed to push open a slider of the tape cartridge storage device and to fix the tape cartridge to the tape cartridge removal tool, the slider being configured to prevent the tape cartridge from moving out of the tape cartridge storage device.

The present invention relates to a tape cartridge removal tool for removing a tape cartridge from a tape cartridge storage device, as well as to a method for removing a tape cartridge from a tape cartridge storage device with a tape cartridge removal tool and a system comprising a tape cartridge storage device, at least one tape cartridge and a tape cartridge removal tool.

### BACKGROUND

System tape cartridges are widely used for information storage of data processing systems, in particular in large computer centers. The tape cartridges are usually stored in large tape cartridge storage devices. Loading and unloading from the tape cartridge storage devices may be done by automatic systems during operation in the computer center. Unloading of the tape cartridges after operation may be done manually. Tools appropriate to remove tape cartridges from slots of tape cartridge storage devices are currently not available. Therefore, users then may use tools not designed for this purpose and can cause damage.

JPS 62277655 A discloses a method for loading and unloading a magnetic tape cartridge in an orientation by receiving a joint into an opening to accommodate the tape cartridge tape when inserted into the loading/unloading module, An arm is spaced apart from the tape cartridge in the standby position and engaging the tape cartridge in response to movement of a handle.

### SUMMARY

A tape cartridge removal tool for removing a tape cartridge from a tape cartridge storage device is proposed, the tape cartridge removal tool comprising: a handle to carry the removed tape cartridge, a support structure to which the handle is attached, having a first side facing the handle and a second side, opposite the first side, two latching hooks, the latching hooks extending from the second side of the support structure away from the handle, wherein the latching hooks are designed to push open a slider of the tape cartridge storage device and to fix the tape cartridge to the tape cartridge removal tool 100, the slider being configured to prevent the tape cartridge from moving out of the tape cartridge storage device, and at least one spacer provided on the second side of the support structure that secures a minimum distance between the second side of the support structure and a front face of the tape cartridge when the latching hooks engage the tape cartridge.

The proposed tape cartridge removal tool enables removal of a tape cartridge from a slot of a tape cartridge storage device of a tape library. The tool may be used by every custom engineer. The tool is easy to manufacture using conventional processes, e.g., by 3D printing, molding, etc. Preferably, the tool is manufactured via 3D printing. The tool is durable and avoids risk for the user of being injured while using it.

With the proposed tool it is possible to remove, e.g. proprietary IBM 3592 tape cartridges, from a so-called HD slot of a 3592 tape library. Yet the tool may advantageously also be adapted for any type of tape cartridge, e.g., linear tape open (LTO) tape cartridges.

The tool may advantageously be manufactured by using the strength and flexibility of a 3D printed part. This enables the tool to spread its arms to slide over the cartridge casing and then use the same spots a usual gripper for automatic handling would use, while sliding away the holding mechanism of a HD slot. This prevents damage to the cartridge, as a similar mechanism is used by the gripper itself.

The user can remove the tape cartridge with the tool from its slot and then from the tool by moving the tape cartridge slightly upwards to release it from the tool.

Advantageously, the user removing the tape cartridges from the tape cartridge storage device may be able to work faster. Fewer people are required. The risk for making mistakes is reduced because a better handling of the tape cartridges is possible.

The tool offers lower production costs and is easy to adapt to other tape cartridge formats.

The proposed tape cartridge removal tool may be provided to customer engineers worldwide. Some of the user may be equipped with their own 3D printer. Costs for shipping the tool are expected to be low, as the tool is small and lightweight because 3D printing allows for hollow parts.

The tool may be printed on a 3D printer in a short time, typically in a few hours. As a material, polylactide (PLA) may be used, and is very user friendly.

A spacer is arranged at a support structure to allow for additional flexibility and to avoid pushing the tool too far into the slot of the tape cartridge storage device.

Advantageously, different materials may be combined for manufacturing the tool, e.g., the lower layers may be printed with thermoplastic polyurethane (TPU), which offers more elasticity, but still is strong, whereas the layers on top may still be printed with PLA or polyethylene terephthalate (PETG).

Printing some layers in between with TPU or combining PLA and TPU in the same layers may also be advantageous.

In an additional or alternative embodiment of the invention, the latching hooks may be arranged at arms extending from the support structure away from the handle. Thus, enough flexibility may be achieved to spread the latching hooks in order to slide over the cartridge casing.

In an additional or alternative embodiment of the invention, the arms may be flexible for bending away from the tape cartridge when the latching hooks are moved towards the tape cartridge and come into contact with the tape cartridge, in particular, when the latching hooks come into contact with chamfers arranged at corners between the front face and both side walls of the tape cartridge. In this manner, the latching hooks may be able to slide around the casing of the tape cartridge to reach recesses in the casing for grabbing the tape cartridge.

The arms may advantageously be flexible because of the material used. In another embodiment, the arms may be fixed to a support unit by a joint with a spring retaining member which enables the latching hooks to slide around the cartridge casing.

In an additional or alternative embodiment of the invention, at least two spacers extend from the second side between the latching hooks. The spacers are positioned relatively a different distance from the respective arm with the latching hook, in particular, each having a different distance from the respective arm with the latching hook. The spacers serve for additional flexibility and to not push the tool too far into the slot. The spacers are offset to the side in order to distribute the pressure from the tool to the front face of the tape cartridge.

In an additional or alternative embodiment of the invention, at least one of the latching hooks may be provided with an outer chamfer for cooperating with the slider, in particular, for pushing the slider away from the tape cartridge. The latching hook may be a bit more rounded at the front to allow easier bending while being pushed against the cartridge casing.

In an additional or alternative embodiment of the invention, the outer chamfer may be configured to cooperate with a corresponding guiding contour of the slider, when the at least one of the latching hooks is moved towards the front face of the tape cartridge. The guiding contour enables a smooth gliding of the corresponding latching hook between slider and cartridge casing.

In an additional or alternative embodiment of the invention, one spacer may be arranged adjacent to each arm with the latching hook, the spacer adjacent to the arm with the latching hook with the outer chamfer having a distance to the arm smaller than a distance of the spacer adjacent to the other arm with the other latching hook. Thus, more pressure may be applied to the front face of the tape cartridge near the slider.

In an additional or alternative embodiment of the invention, the latching hooks may be configured to cooperate with corresponding recesses in the side walls of the casing of the tape cartridge for engaging with the tape cartridge. Reliable fixing of the latching hooks to the cartridge casing may be achieved.

In an additional or alternative embodiment of the invention, the tape cartridge removal tool may be configured to be operatable hand-held by a user. Manual removal of the tape cartridges from the tape cartridge storage device is possible.

Further, a method for removing a tape cartridge from a tape cartridge storage device with a tape cartridge removal tool is proposed, comprising taking hold of the tape cartridge removal tool at a handle; approaching a front face of the tape cartridge with the tape cartridge removal tool, wherein arms with latching hooks pointing to the front face of the tape cartridge; the latching hooks reaching around side walls of the tape cartridge, thereby an outer chamfer of at least one of the latching hooks cooperating with a slider of the tape cartridge storage device; pushing the slider away from the tape cartridge by the outer chamfer of the latching hook, thereby releasing the tape cartridge from the slider; inserting the latching hooks into recesses at the side walls of the casing of the tape cartridge; removing the tape cartridge by pulling the tape cartridge removal tool backwards out of a slot of the tape cartridge storage device.

The proposed method enables removal of a tape cartridge from a slot of a tape cartridge storage device of a tape library by a tape cartridge removal tool. The tool may be used by anyone, including customer engineers. Any risk for the user of being injured while using the tool may be avoided.

With the tool it is possible to remove, e.g., proprietary IBM 3592 tape cartridges from a so-called HD slot of a 3592 tape library. Yet the tool may advantageously also be adapted for any type of tape cartridges, e.g. linear tape open (LTO) tape cartridges.

The user can remove the tape cartridge with the tool from its slot and then from the tool by moving the tape cartridge slightly upwards to release it from the tool.

Advantageously the user removing the tape cartridges from the tape cartridge storage device may be able to work faster. Fewer people are required. The risk for making mistakes is reduced because a better handling of the tape cartridges is possible.

In an additional or alternative embodiment of the invention, the arms may be bent away from the tape cartridge, when the latching hooks are moved towards the tape cartridge and come into contact with the tape cartridge. By this way, the latching hooks may be able to slide around the casing of the tape cartridge to reach recesses for grabbing the tape cartridge.

In an additional or alternative embodiment of the invention, an outer chamfer of at least one of the latching hooks may cooperate with the slider, in particular with a guiding contour of the slider, for pushing the slider away from the tape cartridge. The latching hook may be a bit more round at the front to allow easier bending while being pushed against the cartridge casing.

In an additional or alternative embodiment of the invention, at least one spacer may fix (detachably couple) the front face of the tape cartridge when the latching hooks are engaged in the recesses of the tape cartridge. Thus, the tape cartridge removal tool may be fixed to the tape cartridge in a reliable way.

In an additional or alternative embodiment of the invention, the latching hooks may cooperate with chamfers at corners between the front face and both side walls of the tape cartridge when approaching the front face of the tape cartridge. Thus, smooth gliding of the latching hooks around the cartridge casing is enabled.

In an additional or alternative embodiment of the invention, at least one of the latching hooks may be guided to the guiding contour of the slider when the tape cartridge removal tool is moved towards the front face. The guiding contour enables a smooth gliding of the corresponding latching hook between slider and cartridge casing.

Further, a system comprising a tape cartridge storage device, at least one tape cartridge and a tape cartridge removal tool for removing the tape cartridge from the tape cartridge storage device is proposed. The tape cartridge storage device comprises a slot for accommodating the tape cartridge and a slider which is configured to prevent the tape cartridge from moving out of the slot of the tape cartridge storage device. The tape cartridge has a casing being configured with at least two opposing recesses on both side walls of the casing. The tape cartridge removal tool comprises a handle to carry the removed tape cartridge, a support structure to which the handle is attached, and having a first side facing the handle and a second side, opposite the first side, two latching hooks, the latching hooks extending from the second side of the support structure away from the handle, wherein the latching hooks are designed to push open a slider of the tape cartridge storage device and to fix the tape cartridge to the tape cartridge removal tool, the slider being configured to prevent the tape cartridge from moving out of the tape cartridge storage device, and at least one spacer provided on the second side of the support structure that secures a minimum distance between the second side of the support structure and a front face of the tape cartridge when the latching hooks engage the tape cartridge.

The proposed system comprises components adapted to enable a manual removal of tape cartridges from a tape cartridge storage device. The tape cartridge removal tool enables removal of the tape cartridge from a slot of the tape cartridge storage device of a tape library. The tool may be used by anyone, including customer engineers. The tool is easy to be manufactured, e.g., by 3D printing. The tool is durable and avoids any risk for the user of being injured while using it.

With the tool it is possible to remove, e.g., proprietary IBM 3592 tape cartridges from a so-called HD slot of a 3592 tape library. Yet the tool may advantageously also be adapted for other tape cartridges, e.g., the so-called linear tape open (LTO) tape cartridges.

The tool may advantageously be manufactured by using the strength and flexibility of a 3D printed part. This enables the tool to spread its arms to slide over the cartridge casing and then use the same spots a usual gripper for automatic handling would use, while sliding away the holding mechanism of a HD slot. This prevents damage to the cartridge as a similar mechanism is used by the gripper itself.

The user can remove the tape cartridge with the tool from its slot and then from the tool by moving the tape cartridge slightly upwards to release it from the tool.

Advantageously the user removing the tape cartridges from the tape cartridge storage device may be able to work faster. Fewer people are required. The risk for making mistakes is reduced because a better handling of the tape cartridges is possible.

The tool offers lower production costs and is easy to adapt to other tape cartridge formats.

The tape cartridge removal tool may be easy to provide to customer engineers worldwide. Some of the users may be equipped with their own 3D printer, and thus can print the tool. There are low shipping costs as the tool is small and lightweight as 3D printing allows for hollow parts.

The tool may be printed on a 3D printer in a short time, typically in a few hours. As a material, PLA may be used, and is very user friendly.

A spacer is arranged at a support structure to allow for additional flexibility and to avoid pushing the tool too far into the slot of the tape cartridge storage device.

Advantageously, different materials may be combined for manufacturing the tool. For example, the lower layers may be printed with TPU, which offers more elasticity, but still is strong, whereas the layers on top may still be printed with PLA or polyethylene terephthalate (PETG).

Printing some layers in between with TPU or combining PLA and TPU in the same layers may also be advantageous.

In an additional or alternative embodiment of the invention, the slider may comprise a support unit being fixed to the slot of the tape cartridge storage device, a retaining member with a guiding contour. The retaining member may be configured to be bent away from the tape cartridge for releasing the tape cartridge. The retaining member may be configured as a holding mechanism for preventing the tape cartridge to move out of the tape cartridge storage device. The retaining member may be arranged at the support unit with a spring member to enable to be bent away.

In an additional or alternative embodiment of the invention, the tape cartridge may comprise chamfers at corners between the front face and both side walls of the tape cartridge for being engaged by latching hooks of the tape cartridge removal tool. Thus, smooth gliding of the latching hooks around the cartridge casing is enabled.

In an additional or alternative embodiment of the invention, the tape cartridge may comprise inserting chamfers being configured for pushing the slider outwards when being inserted into the slot of the tape cartridge storage device. In this way, inserting the tape cartridge into the slot of the tape cartridge storage device may be enabled. The inserting chamfers also enable pushing the slider to the side away from the cartridge when moving the tape cartridge into the slot of the tape cartridge storage device.

In an additional or alternative embodiment of the invention, the latching hooks of the tape cartridge removal tool may be arranged at arms extending from the support structure away from the handle. In particular, the arms may be flexible for bending away from the tape cartridge, when the latching hooks are moved towards the front face of the tape cartridge and come into contact with the tape cartridge. By this way, the latching hooks may be able to slide around the casing of the tape cartridge to reach recesses in the casing for grabbing the tape cartridge.

### BRIEF DESCRIPTION OF THE SEVERAL VIEWS OF THE DRAWINGS

Aspects of the present invention together with the above-mentioned and other objects and advantages may best be understood from the following detailed description of the embodiments, but not restricted to the embodiments.

FIG. 1 depicts in an isometric top view a tape cartridge removal tool for removing a tape cartridge from a tape cartridge storage device according to an embodiment of the invention.

FIG. 2 depicts a top view of the tape cartridge removal tool according to FIG. 1.

FIG. 3 depicts in an isometric top view a tape cartridge.

FIG. 4 depicts in a top view a tape cartridge in a tape cartridge storage device.

FIG. 5 depicts in a bottom view the tape cartridge in the tape cartridge storage device according to FIG. 4.

FIG. 6 depicts in a bottom view a system comprising the tape cartridge in the tape cartridge storage device with the tape cartridge removal tool approaching a front face of the tape cartridge.

FIG. 7 depicts in a bottom view the system comprising the tape cartridge in the tape cartridge storage device with the tape cartridge removal tool being pushed further to the front face of the tape cartridge.

FIG. 8 depicts in a bottom view the system comprising the tape cartridge in the tape cartridge storage device with the tape cartridge removal tool being ready for removing the tape cartridge from the tape cartridge storage device.

### DETAILED DESCRIPTION

In the drawings, like elements are referred to with equal reference numerals. The drawings are merely schematic representations, not intended to portray specific parameters of the invention. Moreover, the drawings are intended to depict only typical embodiments of the invention and therefore should not be considered as limiting the scope of the invention.

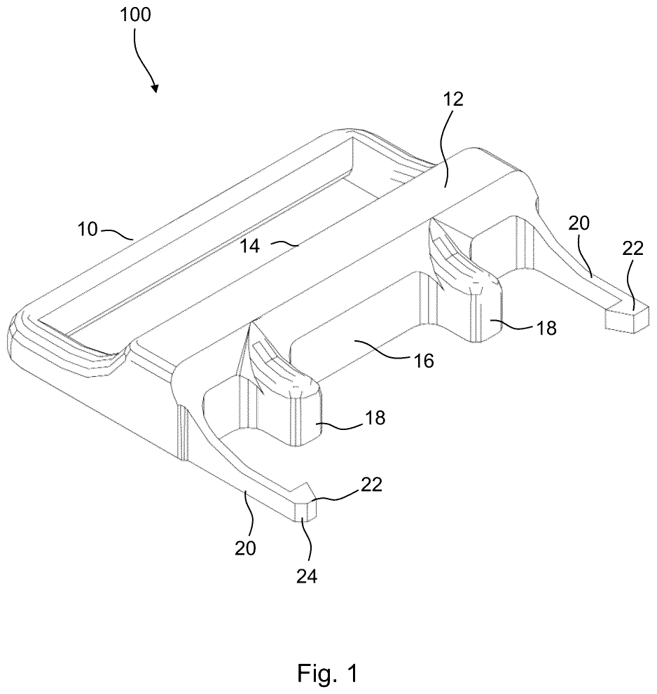

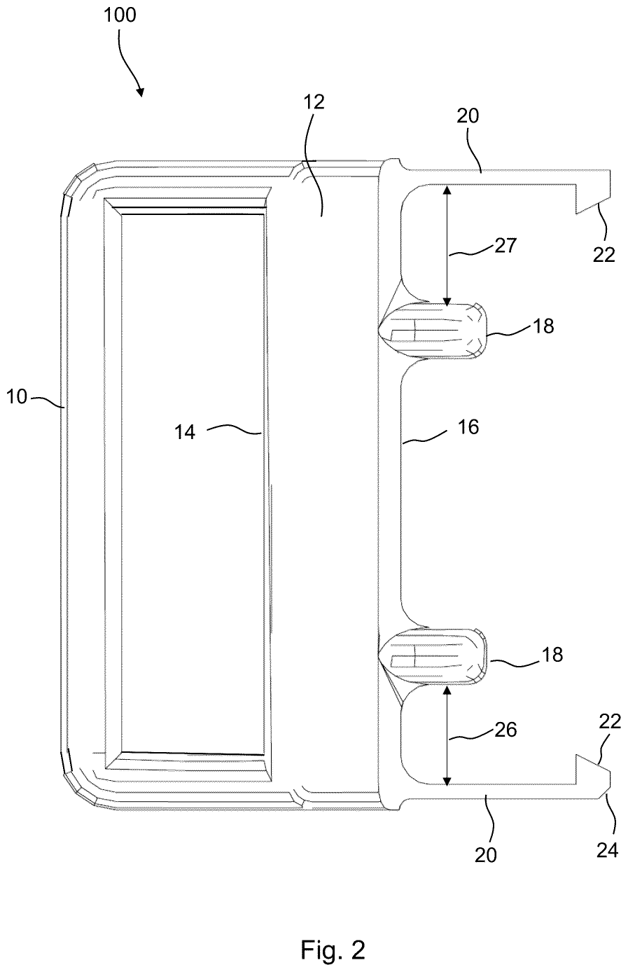

FIG. 1 depicts in an isometric top view a tape cartridge removal tool 100 for removing a tape cartridge 30 from a tape cartridge storage device 50 according to an embodiment of the invention, whereas in FIG. 2 a top view of the tape cartridge removal tool 100 is depicted.

The tape cartridge removal tool 100 may comprise a handle 10 to carry the removed tape cartridge 30 and a support structure 12 to which the handle is attached. The support structure 12 has a first side 14 facing the handle 10 and a second side 16, opposite the first side 14.

The tape cartridge removal tool 100 further comprises two latching hooks 22. The latching hooks 22 extend from the second side 16 of the support structure 12 away from the handle 10. The latching hooks 22 are arranged at arms 20 extending from the support structure 12 away from the handle 10.

Further, the tape cartridge removal tool 100 comprises at least one spacer 18 provided on the second side 16 of the support structure 12.

The two spacers 18 extend from the second side 16 between the latching hooks 22, and as may be seen from FIG. 2, have a different distance 26, 27 from the respective arm 20 with the latching hook 22.

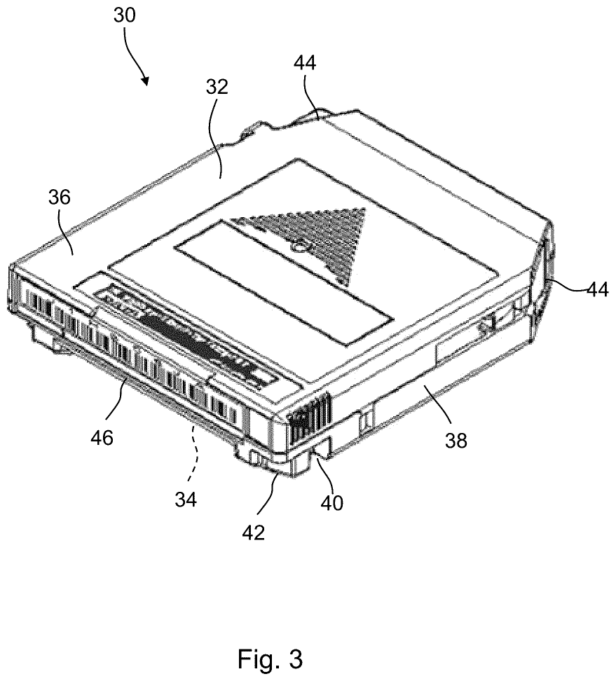

FIG. 3 depicts in an isometric top view a tape cartridge 30.

The tape cartridge 30 has a casing 36 with side walls 38, a top side 32, and a front face 46. Opposite to the front face 46 the casing 36 exhibits inserting chamfers 44 at the corners of the casing 36 for inserting the tape cartridge 30 into a slot of a tape cartridge storage device 50.

Opposing recesses 40 on both side walls 38 are provided which may be engaged by the latching hooks 22 of the tape cartridge removal tool 100.

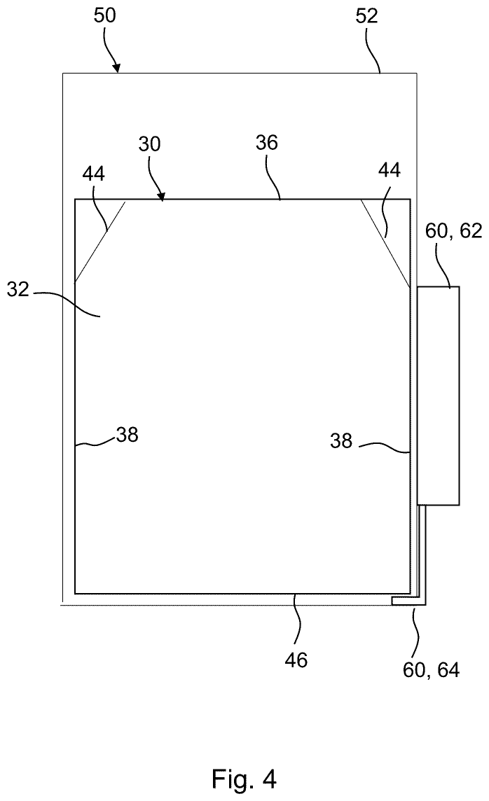

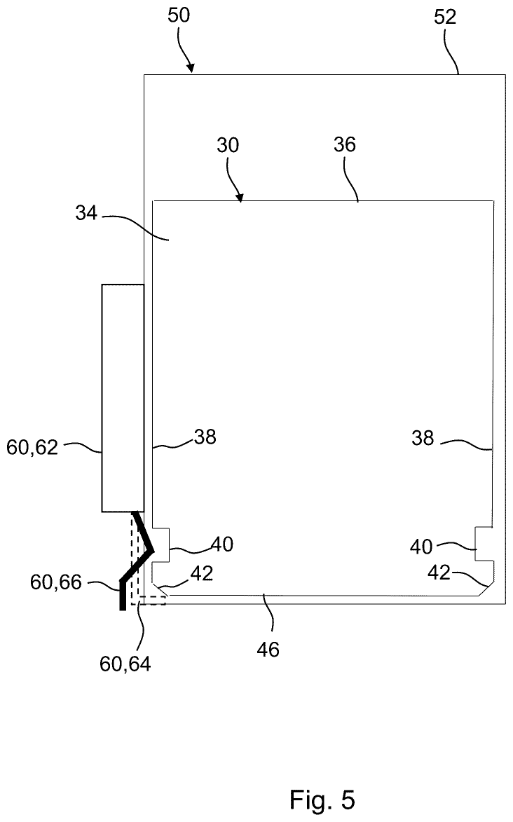

FIG. 4 depicts in a top view a tape cartridge 30 in a tape cartridge storage device 50, whereas in FIG. 5, a bottom view shows the bottom side 34 of the tape cartridge 30 in the tape cartridge storage device 50.

The tape cartridge storage device 50 comprises a slot 52 for accommodating the tape cartridge 30 and a slider 60 which is configured to prevent the tape cartridge 30 from moving out of the slot 52 of the tape cartridge storage device 50.

The slot 52 of the tape cartridge storage device 50 is depicted where the tape cartridge 30 is inserted. At one side of the slot 52 the slider 60 is arranged. The slider 60 is configured to prevent the tape cartridge 30 from moving out of the tape cartridge storage device 50.

The slider 60 comprises a support unit 62 being fixed to the slot 52 of the tape cartridge storage device 50. A retaining member 64 with a guiding contour 66 is connected to the support unit 62. The retaining member 64, being visible in the top view of FIG. 4, is angular shaped for preventing the tape cartridge 30 to move out of the slot 52 under normal operating conditions of the tape cartridge storage device 50.

The guiding contour 66 is in particular visible in the bottom view of FIG. 5, where the retaining member 64 is depicted with broken lines. Both, retaining member 64 and guiding contour 66 are realized and connected to the support unit 62 in one piece.

The retaining member 64 is configured to be bent away from the tape cartridge 30 for releasing the tape cartridge 30. This may be realized by a spring element or by the flexibility of the material itself.

The tape cartridge 30 comprises inserting chamfers 44. By means of these chamfers 44 the slider 60 is pushed outwards when the tape cartridge 30 is inserted into the slot 52 of the tape cartridge storage device 50.

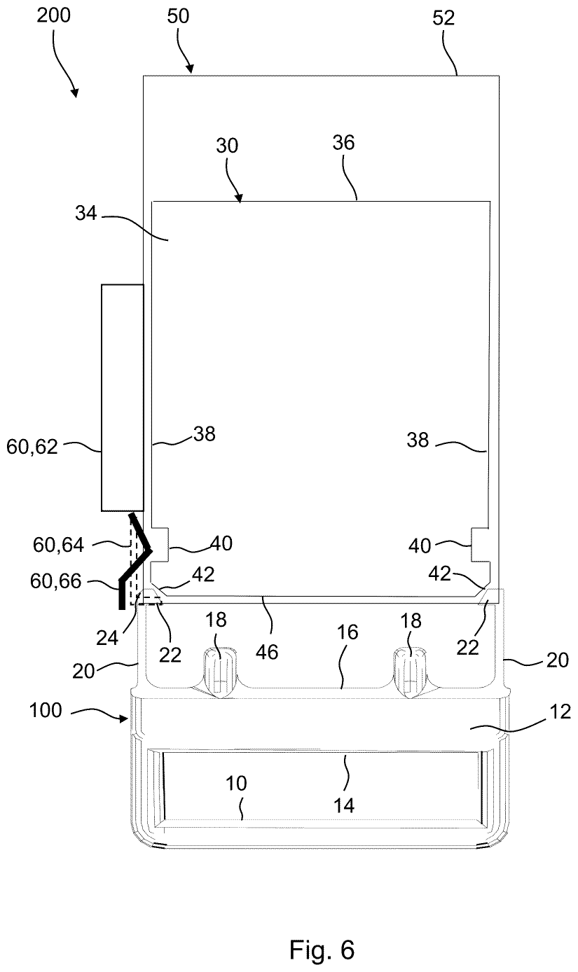

FIG. 6 depicts in a bottom view the system 200 comprising the tape cartridge 30 in the tape cartridge storage device 50 with the tape cartridge removal tool 100 approaching a front face 46 of the tape cartridge 30.

The tape cartridge removal tool 100 may be taking hold of at the handle 10, as it is configured to be operatable hand-held by a user.

The front face 46 of the tape cartridge 30 is approached with the tape cartridge removal tool 100. The arms 20 of the tape cartridge removal tool 100 with the latching hooks 22 point to the front face 46 of the tape cartridge 30.

The latching hooks 22 reach around the side walls 38 of the tape cartridge 30. Thereby an outer chamfer 24 of the left latching hook 22 cooperates with the slider 60 of the tape cartridge storage device 50.

The latching hooks 22 are designed to push open the slider 60 of the tape cartridge storage device 50 and to fix the tape cartridge 30 to the tape cartridge removal tool 100.

The outer chamfer 24 is configured to cooperate with a corresponding guiding contour 66 of the slider 60, when the latching hook 22 is moved towards the front face 46 of the tape cartridge 30.

In the step shown in FIG. 6, the latching hooks 22 just get in touch with the chamfers 42 at corners between the front face 46 and both side walls 38 of the tape cartridge 30 which are configured for being engaged by the latching hooks 22 of the tape cartridge removal tool 100.

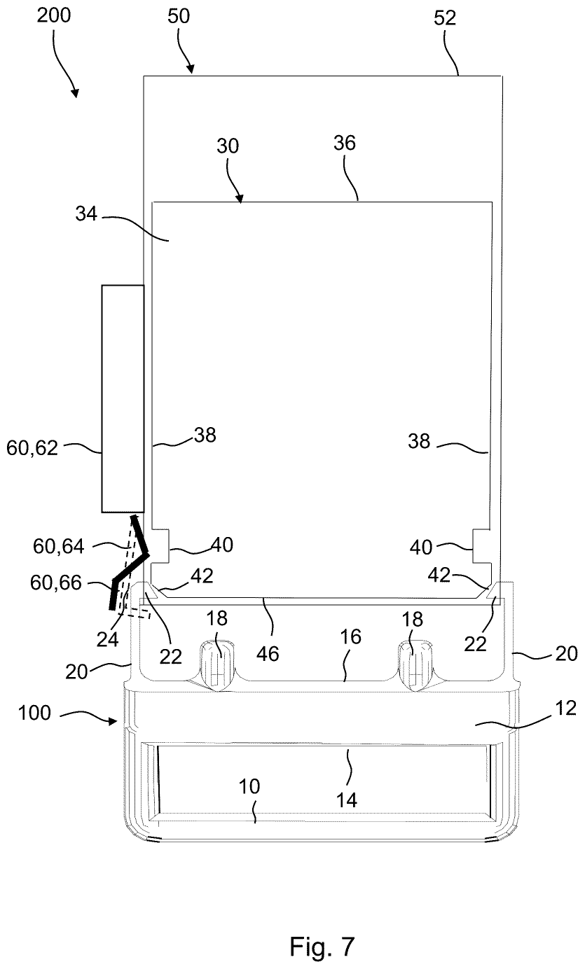

In the next step, shown in FIG. 7, the tape cartridge removal tool 100 is pushed further to the front face 46 of the tape cartridge 30.

The arms 20 are flexible for bending away from the tape cartridge 30, when the latching hooks 22 are moved towards the tape cartridge 30 and come into contact with the tape cartridge 30, in particular, when the latching hooks 22 come into contact with the chamfers 42 arranged at corners between the front face 46 and both side walls 38 of the tape cartridge 30.

Pushing the slider 60 away from the tape cartridge 30 by the outer chamfer 24 of the latching hook 22 releases the tape cartridge 30 from the slider 60.

For this purpose, at least one of the latching hooks 22 is provided with an outer chamfer 24 for cooperating with the slider 60 for pushing the slider 60 away from the tape cartridge 30.

In particular, the outer chamfer 24 of the latching hook 22 cooperates with the guiding contour 66 of the slider 60, for pushing the slider 60 away from the tape cartridge 30.

If only one latching hook 22 is provided with such an outer chamfer 24, it must be paid attention when approaching the slot 52 that the latching hook 22 provided with the outer chamfer 24 is positioned at the side of the slider 60. If both latching hooks 22 are provided with such an outer chamfer 24 then the tape cartridge removal tool 100 may be used from both sides.

In FIG. 7, the arms 20 are bent away from the tape cartridge 30, moving outward and glide along the side walls 38.

The latching hooks 22 cooperate with the chamfers 42 at corners between the front face 46 and both side walls 38 of the tape cartridge 30 when approaching the front face 46 of the tape cartridge 30.

The latching hook 22 with the outer chamfer 24 is guided to the guiding contour 66 of the slider 60 when the tape cartridge removal tool 100 is moved towards the front face 46.

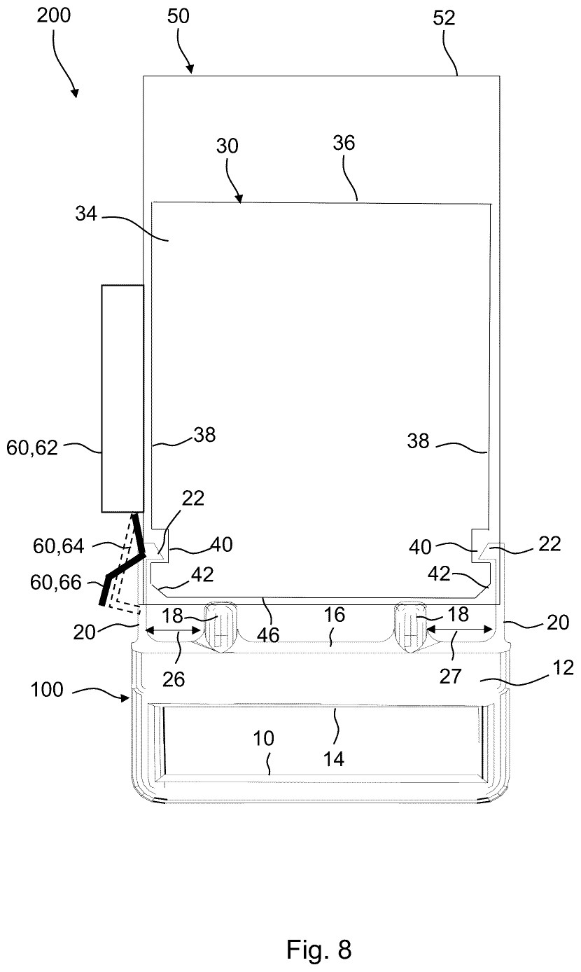

In FIG. 8, the next step is shown where the tape cartridge removal tool 100 is ready for removing the tape cartridge 30 from the tape cartridge storage device 50.

The latching hooks 22 are inserted into the recesses 40 at the side walls 38 of the casing 36 of the tape cartridge 30. Thus, the tape cartridge 30 may be removed from the tape cartridge storage device 50 by pulling the tape cartridge removal tool 100 backwards out of a slot 52 of the tape cartridge storage device 50.

The spacers 18 fix the front face 46 of the tape cartridge 30 when the latching hooks 22 are engaged in the recesses 40 of the tape cartridge 30. Thus, a minimum distance between the second side 16 of the support structure 12 and the front face 46 of the tape cartridge 30 is secured, when the latching hooks 22 engage the tape cartridge 30.

One spacer 18 is arranged adjacent to each arm 20 with the latching hook 22. The spacer 18 adjacent to the arm 20 with the latching hook 22 with the outer chamfer 24 has a distance 26 to the arm 20 smaller than a distance 27 of the spacer 18 adjacent to the other arm 20 with the other latching hook 22. The spacers 18 with the smaller distance 26 may be able to put more force to the front face 46 at the side where the slider 60 is located because the distance 26 between the corresponding arm 20 and the spacer 18 is smaller.

Further, the spacers 18 serve for additional flexibility and to not push the tool 100 too far into the slot 52 when approaching the tape cartridge 30.

### REFERENCE NUMERALS

10 handle
12 support structure
14 first side
16 second side
18 spacer
20 arm
22 latching hook
24 outer chamfer
26 distance
27 distance
30 tape cartridge
32 top side
34 bottom side
36 casing
38 side wall
40 recess
42 chamfer
44 inserting chamfer
46 front face
50 tape cartridge storage device
52 slot
60 slider
62 support unit
64 retaining member
66 guiding contour
100 tape removal tool
200 system

1. A tape cartridge removal tool for removing a tape cartridge from a tape cartridge storage device, the tape cartridge removal tool comprising:
a handle to carry the removed tape cartridge;
a support structure to which the handle is attached, having a first side facing the handle and a second side, opposite the first side;
two latching hooks, the latching hooks extending from the second side of the support structure away from the handle, wherein the latching hooks are designed to push open a slider of the tape cartridge storage device and to fix the tape cartridge to the tape cartridge removal tool, the slider being configured to prevent the tape cartridge from moving out of the tape cartridge storage device; and
at least one spacer provided on the second side of the support structure that secures a minimum distance between the second side of the support structure and a front face of the tape cartridge when the latching hooks engage the tape cartridge.

2. The tape cartridge removal tool according to claim 1, wherein the latching hooks are arranged at arms extending from the support structure away from the handle.

3. The tape cartridge removal tool according to claim 2, wherein the arms are flexible for bending away from the tape cartridge when the latching hooks are moved towards the tape cartridge and come into contact with the tape cartridge.

4. The tape cartridge removal tool according to claim 2, wherein at least two spacers extend from the second side between the latching hooks, wherein the spacers are positioned relatively a different distance from the respective arm with the latching hook.

5. The tape cartridge removal tool according to claim 1, wherein at least one of the latching hooks is provided with an outer chamfer for cooperating with the slider for pushing the slider away from the tape cartridge.

6. The tape cartridge removal tool according to claim 5, wherein the outer chamfer is configured to cooperate with a corresponding guiding contour of the slider when the at least one of the latching hooks is moved towards the front face of the tape cartridge.

7. The tape cartridge removal tool according to claim 6, wherein one spacer is arranged adjacent to each arm with the latching hook, the spacer adjacent to the arm with the latching hook with the outer chamfer having a distance to the arm smaller than a distance of the spacer adjacent to the other arm with the other latching hook.

8. The tape cartridge removal tool according to claim 1, wherein the latching hooks are configured to cooperate with corresponding recesses in side walls of a casing of the tape cartridge for engaging with the tape cartridge.

9. The tape cartridge removal tool according to claim 1, configured to be operatable hand-held by a user.

10. A method for removing a tape cartridge from a tape cartridge storage device with the tape cartridge removal tool of claim 1, the method comprising:
taking hold of the tape cartridge removal tool at a handle;
approaching a front face of the tape cartridge with the tape cartridge removal tool, wherein arms with latching hooks pointing to the front face of the tape cartridge;
the latching hooks reaching around side walls of the tape cartridge, thereby an outer chamfer of at least one of the latching hooks cooperating with a slider of the tape cartridge storage device;
pushing the slider away from the tape cartridge by the outer chamfer of the latching hook, thereby releasing the tape cartridge from the slider;
inserting the latching hooks into recesses at the side walls of the casing of the tape cartridge; and
removing the tape cartridge by pulling the tape cartridge removal tool backwards out of a slot of the tape cartridge storage device.

11. The method according to claim 10, wherein the arms bend away from the tape cartridge when the latching hooks are moved towards the tape cartridge and come into contact with the tape cartridge.

12. The method according to claim 10, wherein an outer chamfer of at least one of the latching hooks cooperates with the slider for pushing the slider away from the tape cartridge.

13. The method according to claim 10, wherein at least one spacer fixes the front face of the tape cartridge when the latching hooks are engaged in the recesses of the tape cartridge.

14. The method according to claim 10, wherein the latching hooks are cooperating with chamfers at corners between the front face and both side walls of the tape cartridge when approaching the front face of the tape cartridge.

15. The method according to claim 10, wherein at least one of the latching hooks is guided to a guiding contour of the slider when the tape cartridge removal tool is moved towards the front face.

16. A system comprising a tape cartridge storage device, at least one tape cartridge and a tape cartridge removal tool for removing the tape cartridge from the tape cartridge storage device according to claim 1,
wherein the tape cartridge storage device comprises a slot for accommodating the tape cartridge and a slider which is configured to prevent the tape cartridge from moving out of the slot of the tape cartridge storage device,
wherein the tape cartridge has a casing being configured with at least two opposing recesses on both side walls of the casing,
wherein the tape cartridge removal tool comprises:
a handle to carry the removed tape cartridge,
a support structure to which the handle is attached, and having a first side facing the handle and a second side, opposite the first side,
two latching hooks, the latching hooks extending from the second side of the support structure away from the handle, wherein the latching hooks are designed to push open a slider of the tape cartridge storage device and to fix the tape cartridge to the tape cartridge removal tool, the slider being configured to prevent the tape cartridge from moving out of the tape cartridge storage device,
at least one spacer provided on the second side of the support structure that secures a minimum distance between the second side of the support structure and a front face of the tape cartridge when the latching hooks engage the tape cartridge.

17. The system according to claim 16, wherein the slider comprises:
a support unit being fixed to the slot of the tape cartridge storage device,
a retaining member with a guiding contour,
wherein the retaining member is configured to be bent away from the tape cartridge for releasing the tape cartridge.

18. The system according to claim 16, wherein the tape cartridge comprises chamfers at corners between the front face and both side walls of the tape cartridge for being engaged by latching hooks of the tape cartridge removal tool.

19. The system according to claim 16, wherein the tape cartridge comprises inserting chamfers being configured for pushing the slider outwards when being inserted into the slot of the tape cartridge storage device.

20. The system according to claim 16, wherein the latching hooks of the tape cartridge removal tool are arranged at arms extending from the support structure away from the handle,
in particular, wherein the arms are flexible for bending away from the tape cartridge, when the latching hooks are moved towards the front face of the tape cartridge and come into contact with the tape cartridge.
